(19) United States
(12) Patent Application Publication
(10) Pub. No.: US 2009/0020688 A1
(43) Pub. Date: Jan. 22, 2009

(54) Workpiece sensor

(76) Inventors: Christopher Scott Lovchik, Pearland, TX (US); Christopher G. Morlier, League City, TX (US); Jonathan Heeth, Deer Park, TX (US); Brit Yenne, Pearland, TX (US)

Correspondence Address: TROP PRUNER & HU, PC, 1616 S. VOSS ROAD, SUITE 750, HOUSTON, TX, 77057-2631, US

(21) Appl. No.: 11/880,439

(22) Filed: Jul. 20, 2007

(51) Int. Cl. H01J 40/14

(52) U.S. Cl. 250/215; 250/578.1

(57) ABSTRACT

In one embodiment, the present invention includes a sensor that has an enclosure to house a photodetector and a pair of light sources. The photodetector may be used to detect presence of a workpiece in a machine based on reflected energy from a surface of the workpiece, and the light sources may be adapted on opposing sides of the photodetector to illuminate the workpiece.

### BACKGROUND

In many computer numerically controlled (CNC) machines, a workpiece is placed into the machine and is modified by operation of the machine, which may execute various instructions to provide a desired form to the workpiece using cutting tools, drilling tools, shaping tools and so forth. While many workpieces are formed of relatively rigid materials such as metals, woods and so forth, they can become deformed during machine operation.

Furthermore, when operated on in a CNC machine using a traction or other such drive system, it is important to maintain an accurate determination of positioning of the workpiece. For example, workpiece slippage or drag may occur. Because of the automated and predetermined nature of the operations to be performed on the workpiece, such slippage, deformation or other excursions from a nominal position can negatively affect the results, particularly where finely controlled actions are needed. For example, in carving a design into a workpiece unintentional slippage or drag of the workpiece can cause a stairstep pattern or other undesirable result, or can cause damage or breakage of a tool. Further, damage can result if a tool unexpectedly encounters no resistance as a result of a workpiece exiting past a location of the tool. A need thus exists for improved manners of accurately determining workpiece positioning.

### BRIEF DESCRIPTION OF THE DRAWINGS

FIG. 1 is a plan view of a sensor in accordance with one embodiment of the present invention.

FIG. 2 is an assembly drawing including various components of a sensor assembly in accordance with one embodiment of the present invention.

FIG. 3 is a reverse side of a sensor assembly in accordance with one embodiment of the present invention.

FIG. 4 is an overall view of a processor controlled machine in accordance with one embodiment of the present invention.

FIG. 5 is a perspective view of a y-and-z-axes assembly of a machine of one embodiment.

### SUMMARY OF THE INVENTION

In one embodiment, the present invention includes an apparatus having an enclosure to house a photodetector and a pair of light sources. The photodetector can detect presence of a workpiece in a machine based on reflected energy from a surface of the workpiece when the workpiece is in optical view of the photodetector, and the light sources may be adapted on opposing sides of the photodetector to illuminate the workpiece. The apparatus may further include a circuit board to provide power to the pair of light sources and to receive a detection signal from the photodetector to be processed by detection circuitry. The apparatus may further communicate information regarding detection of the workpiece to a processor of the machine. In one particular implementation, the light sources may be light emitting diodes and the photodetector may be a photo transistor, with the light emitting devices adapted at an angle with respect to the photo transistor.

Yet another aspect of the present invention is directed to a sensor assembly including a housing to house a photo transistor and a pair of LEDs, which can be used to detect presence of a workpiece in a processor-controlled carving system based on reflected energy from a surface of the workpiece when it is in optical view of the photo transistor. The pair of LEDs can be adapted on opposing sides of the photo transistor to illuminate the workpiece. The sensor assembly may further include a substrate having circuitry to provide power to the pair of LEDs and to receive a detection signal from the photo transistor, and to process the detection signal and to communicate information regarding detection of the workpiece to a processor of the processor-controlled carving system.

A still further embodiment of the present invention may include a moving assembly to support a tool holder assembly and to enable movement along at least a first axis. The moving assembly includes a first pair of rollers coupled on sides of the moving assembly to mate with a corresponding track member to enable movement of the moving assembly along the first axis and a sensor assembly coupled to a peripheral portion of the moving assembly, such as described above.

### DETAILED DESCRIPTION

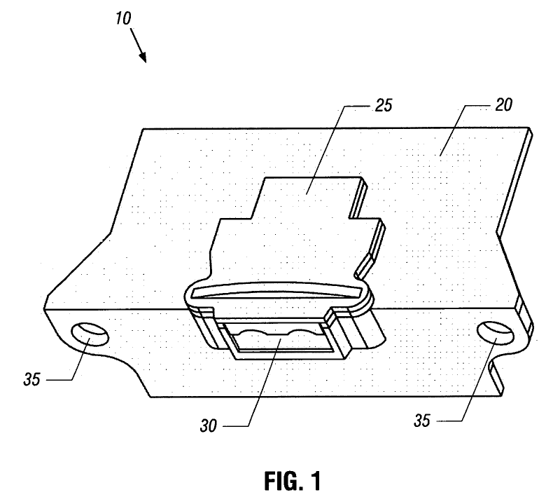

Referring now to FIG. 1, shown is a plan view of a sensor in accordance with one embodiment of the present invention. As shown in FIG. 1, sensor 10 may be used to sense position of a workpiece within a system. More specifically, sensor 10 may be adapted on a moving assembly of the system, e.g., in proximity to a cutting head, to provide detection of a workpiece, and further to provide an indication of when movement of the workpiece by a drive assembly of the system causes an edge of the workpiece to be close to a line of sight of the sensor.

As shown in FIG. 1, sensor 10 may include a housing 20 which may be used to house various components of the sensor including one or more light sources and at least one sensing mechanism such as a photodetector. Still further, a backside of housing 20 may be used to support a substrate such as a circuit board that includes various components to enable operation of sensor assembly 10. As further shown in FIG. 1, a cover 25 may be removably attached to housing 20 to provide a protective enclosure for the light sources and photodetector. Furthermore, a window 30 may provide a protective transparent opening through which transmitted optical energy may be transmitted by the one or more light sources and in turn, reflective optical energy may be received by the photodetector. Furthermore, a pair of mounting holes 35 may be used in mounting sensor assembly 10 to the system. For example, in some implementations sensor assembly 10 may be coupled to a moving assembly on which a cutting head may be moveably connected.

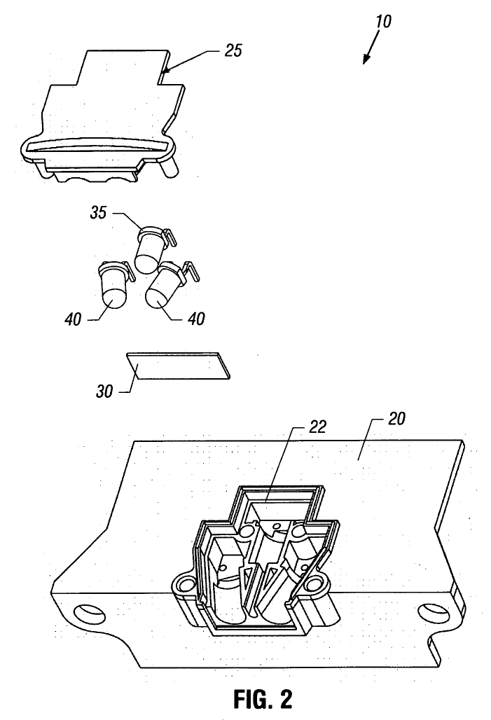

Referring now to FIG. 2, shown is an assembly drawing including various components of sensor assembly 10. Specifically, FIG. 2 shows housing 20 without cover 25 attached. As shown in FIG. 2, housing 20 includes a chamber (generally 22) which includes a pair of recesses 23 to house a pair of light sources and a second recess 24 which may house the photodetector. Note that in the embodiment of FIG. 2, recesses 23 may be angled or bent, and may be adapted on either side of recess 24. Further, note that a narrow channel may be located at a front portion of recess 24 to provide for even entry of a narrow amount of optical energy, i.e., reflected light from a workpiece or other underlying surface of a workpiece support member of a system.

Also shown in FIG. 2 is a window 30, which may be a piece of clear plastic. FIG. 2 also shows a photodetector 35 and a pair of light emitting diodes (LEDs) 40. Note that in the implementation of FIG. 2, photodetector 35 and LEDs 40 are shown in substantially the same relative position as when adapted within housing 20. Specifically, LEDs 40 may be forward of and angled with respect to photodetector 35. Note that in the embodiment of FIG. 2, LEDs 40 may have bent leads to enable their adaptation within recesses 23 of housing 20. In the embodiment of FIG. 2, photodetector 35 may be a photo transistor, although the scope of the present invention is not limited in this regard.

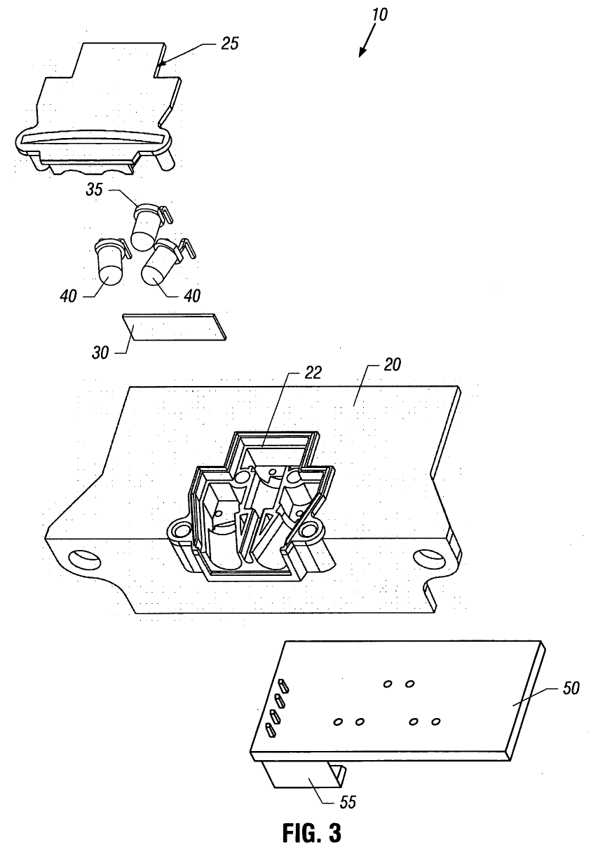

Referring now to FIG. 3, shown is another view of sensor assembly 10. As shown in FIG. 3, a circuit board 50 is present, which may be adapted to housing 10. Specifically, the leads of photodetector 35 and LEDs 40 may be passed through holes within chamber 22 and coupled to circuit board 50. As shown in the embodiment of FIG. 3, circuit board 50 may include contact holes through which the leads may be passed and soldered on a reverse side of circuit board 50. In other embodiments, a surface mount or other such contact between photodetector 35 and LEDs 40 and circuit board 50 may be realized. Also shown in FIG. 3, on a rear side of circuit board 50 is a connector 55 to which in turn a cable may be coupled to provide information regarding the sensed data from sensor assembly 10 to a processor of the system. Furthermore, connector 55 may provide power inputs from the system to sensor assembly 10. Various circuitry may be present on circuit board 50 for powering the light sources and photodetector, as well as receiving detected information from the photodetector and processing it to provide, e.g., digital data to a processor of the system. While shown with this particular implementation in the embodiment of FIGS. 1-3, understand that a sensor in accordance with an embodiment of the present invention may take many different forms.

While the scope of the present invention is not limited in this regard, in some implementations a sensor array may be adapted to operate in a CNC machine such as the processor-controlled carving machine set forth in U.S. Pat. Nos. 6,859,988 and 7,140,089 commonly assigned herewith, and disclosures of which are hereby incorporated by reference.

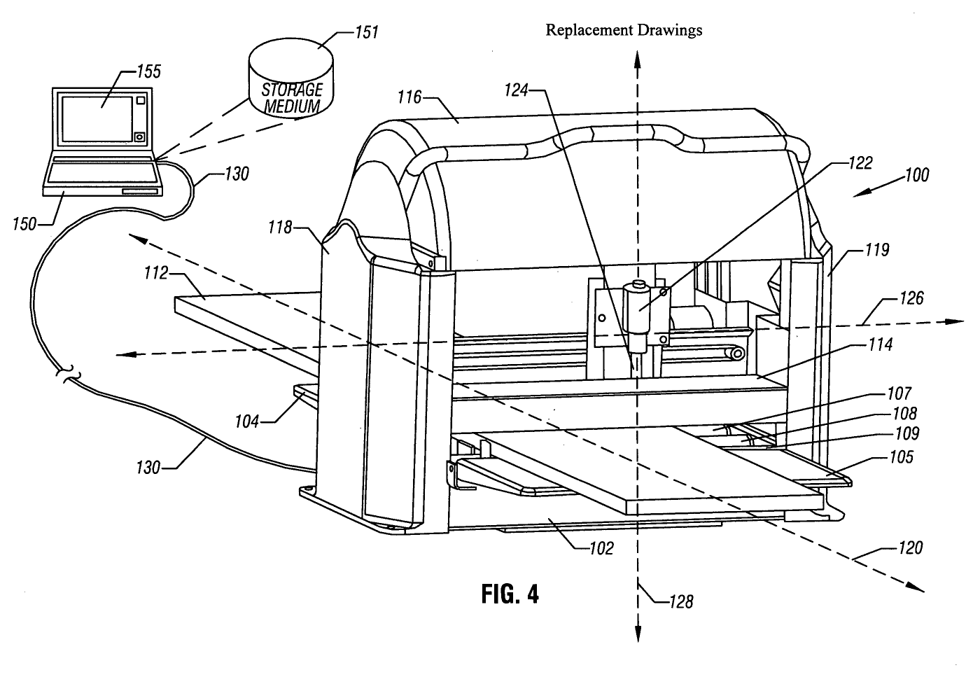

Referring now to FIG. 4, shown is an overall view of a processor controlled machine 100 which includes a base 102, feed trays 104 and 105, and lower rollers 107 and 109 (one lower roller obscured in FIG. 4) that together form a horizontal surface that supports and horizontally translates a workpiece 112, a head assembly 114, and top 116 and side 118, 119 covers that cover an internal frame that supports the head assembly 114 in a position above the workpiece 112. The head assembly 114 includes two clamping rollers (not shown in FIG. 4) that clamp the workpiece 112 between the clamping rollers and lower rollers 107, 109. The lower rollers are motor driven to translate the workpiece 112 both forward and backward in a horizontal, or x, direction 120. The head assembly 114 includes a cutting head assembly 122 that includes a bit adapter 124 that holds a drilling, cutting, shaping, routing, or other type of tool that is rotated and that is positioned onto, and moved across and into, the workpiece 112 in order to carve and shape the workpiece. While not shown in FIG. 4, cutting head assembly 122 may have one or more wiper mechanisms that are coupled about rollers of the assembly. The head assembly 114 includes lateral and vertical translation means to translate, under processor control, the cutting head assembly 122 in a lateral, or y, direction 126 and in a vertical, or z, direction 128, respectively. Similar wiper mechanisms may be present in head assembly 114.

Processor control of the cutting head assembly 122 in the y and z directions 126 and 128, and processor control of the workpiece 112 in the x direction 120, allows for arbitrary positioning of the cutting, drilling, shaping, routing, or other tool with respect to the workpiece 112 and for moving the drilling, cutting, shaping, routing, or other bit in arbitrary straight-lines, 2-dimensional curves, across 2-dimensional surfaces arbitrarily oriented in three dimensions, and in 3-dimensional curves in order to drill, cut, shape, and rout the workpiece in an almost limitless number of ways. Various sensors, including a sensor in accordance with an embodiment of the present invention, may communicate information regarding the positions and shapes of the workpiece 112. For example, the machine may include a load-sensing sensor that can sense and report to the processor the speed of the motor driving the rotation of the cutting head, so that the machine can adjust the weight of the workpiece and cutting-head assembly translation in order to maintain a relatively even load on a drilling, cutting, routing, shaping, or other type of bit.

The processor controller may be connected to a host PC or other computer system via a computer-connection cable 130. The processor is responsible for real-time control of the machine and for stand-alone control of the machine. In many applications, overall control of the machine may be the responsibility of a host computer system, such as host personal computer 150, interconnected with the processor via the computer-connection cable 130, shown in FIG. 4. The processor may thus monitor environmental inputs from various sensors included in the machine, which may include sensors to detect the shape and position of the workpiece, the load on the cutting head, temperature of various positions and of various components of the machine, and other sensors. The host PC 150 may generate command sequences based on stored designs, templates, and directives generated partially or completely as a result of interaction of a human user with the host PC 150, and transmits the commands to the processor, which then controls the components to effect each command. The processor facilitates safe operation of the machine by sensing, via various sensors embedded in the machine unsafe conditions, and shutting down one or more components, such as the motors driving rotation of the cutting head and translation of the workpiece and cutting-head assembly, to prevent catastrophic failures. The processor may include or be coupled to memory to store a variety of command sequences to allow for a command-based, stand-alone operation initiated and directed by a user through a control panel independent of host PC 150. The host PC 150 provides a GUI 155 that allows a user to draw, or compose, designs and templates reflecting an almost limitless number of combinations of elementary operations defined by a combination of a particular drilling, cutting, routing, shaping, or other bit with positions, lines, and curves. As shown in FIG. 4, a computer-readable storage medium 151 (schematically shown) may be coupled to host computer 150. Alternately, the machine may include one or more ports to receive removable storage media, to download one or more sets of instruction to control execution of operations on the machine.

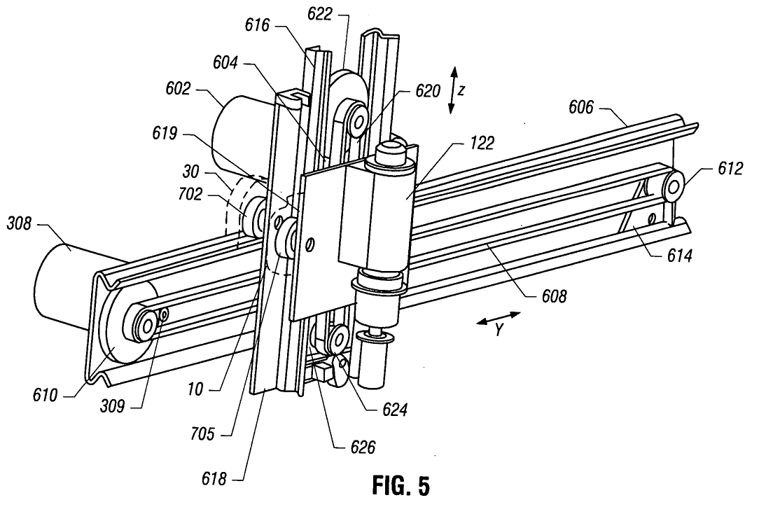

Referring now to FIG. 5, shown is a perspective view of a y-and-z-axes assembly of a machine of one embodiment. As shown in FIG. 5, the y-axis tooth belt 608 is mounted to the y-axis drive gear and tooth pulley 610 and y-axis return pulley 612 to translate the y-axis truck assembly 618 in the y-direction. The y-axis tooth belt 608 is attached to the y-axis truck assembly 618 through a belt crimp. The y-axis truck assembly 618 rolls within the y-axis track via a number of ball-bearing rollers 702, one of which is partially shown in FIG. 5. Similarly, the z-axis truck assembly 619 is attached to the z-axis tooth belt 620 through a belt crimp to allow the cutting-head assembly 122 to be translated in the z-direction by rolling upwards and downwards in the z-track 616, driven by the z-axis axis drive motor 602 via the z-axis drive gear and tooth pulley 622. The z-axis tooth belt 620 is mounted to grooves in the z-axis drive gear and tooth pulley 622 and the z-axis tooth return pulley 624. The y-axis return pulley is mounted to the y-axis tensioner plate 614, in turn fixed to the y-axis track 606, and the z-axis return pulley 624 is mounted to the z-axis tensioner plate 626 that is in turn mounted to the z-axis track 616. As shown in FIG. 5, the z-axis drive-motor pinion 309 is rotated by the y-axis drive motor 308 and is enmeshed with the y-axis drive gear 610 to transfer mechanical rotation to the y-axis drive gear and tooth pulley 610. A similar configuration is used to transfer mechanical rotation from the z-axis drive motor pinion 604 to the z-axis drive gear and tooth pulley 622.

As further shown in FIG. 5, sensor assembly 100, which may be in accordance with the FIG. 1 embodiment, may be adapted to a bottom portion of the y-axis truck assembly 618 to sense a location and positioning of a workpiece within the system. More specifically, by providing power to the light sources, e.g., LEDs 40, a workpiece may be illuminated to better provide for reflective energy to be received by photodetector 35. In this way, improved accuracy and measurement of board location may be realized. For example, by the illumination provided, workpieces at a distance of at least several inches from sensor assembly 100 may be detected.

Various detection schemes may be provided in order to generate an accurate measurement of workpiece location. For example, a processor of sensor assembly 100 may be programmed to implement a routine to generate a location measurement such that when an edge of a workpiece is near a vertical axis along which photodetector 35 is aligned (i.e., near a line of sight of photodetector 35), the routine may generate a measurement of the board location based on illumination reflection from light sources on opposing sides of the detector such that a distance measurement is at a substantial midpoint of a linear difference between the two light sources. To effect such detection and computation, an algorithm may be stored in a machine readable medium such as software or firmware to be executed by the processor of sensor assembly 100.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An apparatus comprising:
an enclosure to house a photodetector and a pair of light sources, wherein the photodetector is to detect presence of a workpiece in a machine based on reflected energy from a surface of the workpiece when the workpiece is in optical view of the photodetector, wherein the pair of light sources are adapted on opposing sides of the photodetector to illuminate the workpiece.

2. The apparatus of claim 1, further comprising a circuit board adapted to the enclosure, the circuit board to provide power to the pair of light sources and to receive a detection signal from the photodetector, wherein the circuit board further includes detection circuitry to process the detection signal and to communicate information regarding detection of the workpiece to a processor of the machine.

3. The apparatus of claim 2, wherein the detection circuitry is to estimate position of the workpiece with respect to a mid point between the pair of light sources.

4. The apparatus of claim 1, wherein the apparatus is adapted to a moving assembly of the machine, the moving assembly to move along a first axis, wherein the moving assembly is maintained at a substantially constant distance from the workpiece position with respect to a second axis.

5. The apparatus of claim 1, wherein the plurality of light sources comprises light emitting diodes and the photodetector comprises a photo transistor.

6. The apparatus of claim 5, wherein the light emitting diodes are adapted at an angle with respect to the photo transistor.

7. The apparatus of claim 1, wherein the enclosure comprises a channel defined between the pair of light sources, wherein the photodetector is located at a rearward portion of the channel, a forward portion of the channel adjacent to a window of the enclosure.

8. The apparatus of claim 7, wherein the pair of light sources are adjacent to the window and forward of the photodetector and angled with respect thereto.

9. A sensor assembly comprising:
a housing to house a photo transistor and a pair of light emitting diodes (LEDs), wherein the photo transistor is to detect presence of a workpiece in a processor-controlled carving system based on reflected energy from a surface of the workpiece when the workpiece is in optical view of the photo transistor, wherein the pair of LEDs are adapted on opposing sides of the photo transistor to illuminate the workpiece; and
a substrate coupled to the housing, the substrate including circuitry to provide power to the pair of LEDs and to receive a detection signal from the photo transistor, wherein the substrate further includes detection circuitry to process the detection signal and to communicate information regarding detection of the workpiece to a processor of the processor-controlled carving system.

10. The sensor assembly of claim 9, wherein the housing comprises a chamber having a pair of angled recesses each to house one of the LEDs and a central recess having a channel defined between the pair of angled recesses, wherein the photo transistor is located at a rearward portion of the central recess and the pair of LEDs are angled with respect to the photo transistor.

11. The sensor assembly of claim 10, wherein the pair of LEDs are adjacent to a window at forward portion of the chamber, and the photo transistor is located rearwardly with respect to the LEDs.

12. The sensor assembly of claim 10, wherein leads of the LEDs extend through the housing and are affixed to the substrate and leads of the photo transistor extend through the housing and are affixed to the substrate, the leads to adapt the substrate to the housing.

13. The sensor assembly of claim 10, further comprising a transparent window at a front portion of the housing, wherein the transparent window is to enable the optical view for the photo transistor.

14. An apparatus comprising:
a moving assembly to support a tool holder assembly and to enable movement along at least a first axis, the moving assembly including:
a first pair of rollers coupled on a first and second side of the moving assembly, the first pair of rollers to mate with a corresponding track member to enable movement of the moving assembly along the first axis; and
a sensor assembly coupled to a peripheral portion of the moving assembly, the sensor assembly including an enclosure to house a photodetector and a pair of light sources, wherein the photodetector is to detect presence of a workpiece based on reflected energy from a surface of the workpiece when the workpiece is in optical view of the photodetector, wherein the pair of light sources are adapted on opposing sides of the photodetector to illuminate the workpiece.

15. The apparatus of claim 14, further comprising a circuit board adapted to the enclosure, the circuit board to provide power to the pair of light sources and to receive a detection signal from the photodetector, wherein the circuit board further includes detection circuitry to process the detection signal and to communicate information regarding detection of the workpiece to a processor.

16. The apparatus of claim 14, wherein the moving assembly is maintained at a substantially constant distance from a position of the workpiece with respect to a second axis.

17. The apparatus of claim 14, wherein the tool holder assembly is to enable movement along a second axis so that a tool adapted in the tool holder assembly can contact the workpiece.

18. The apparatus of claim 17, wherein the sensor assembly is coupled in close proximity to the tool.
